(19) United States
(12) Patent Application Publication
(10) Pub. No.: US 2005/0267983 A1
(43) Pub. Date: Dec. 1, 2005

(54) Method for automatically numbering a network using the internet protocol

(75) Inventors: Vladimir Ksinant, ISSY-LES-MOULINEAUX (FR); Jean-Mickael Guerin, Issy-Les-Moulineaux (FR); Alain Ritoux, Paris (FR)

Correspondence Address: BROWDY AND NEIMARK, P.L.L.C.;624 NINTH STREET, NW, SUITE 300, WASHINGTON, DC, 20001-5303, US

(73) Assignee: 6 WIND, MONTIGNY LE BRETONNEUX (FR)

(21) Appl. No.: 10/522,884

(22) PCT Filed: Jul. 29, 2003
(86) PCT No.: PCT/FR03/02403

§ 371 Date: Feb. 1, 2005

(51) Int. Cl. G06F 15/173

(52) U.S. Cl. 709/238

(57) ABSTRACT

Disclosed is a method that uses the routing functions of an internet-type protocol by introducing a mechanism assigning prefixes to the IPv6 addresses of the network routers such that the self-configuration process of said protocol can be used due to a mechanism that utilizes a serializer (E). Said serializer (E) delivers the prefixes according to an operational sequence comprising, for each router, an initialization phase, a configuration phase, and a relay phase in which the router is used as an intermediary between the serializer and other routers that are in the configuration phase.

The invention relates to a method for automatic network dialing using the Internet Protocol.

Generally speaking we know that networks are increasingly interconnected and the complexity of their topology is constantly increasing. Hence, the digitising of new networks or displaced networks is proving to be ever more fastidious.

Therefore, the purpose of the invention is more specifically to reduce the administrative and managerial load of networks by limiting the manual configuration operations associated with dialing and to facilitate network deployment and in particular local area networks (LAN).

For this reason, it proposes a method that automatically allocates dialing prefixes of Ipv6 type to the routers in which, according to Ipv6 protocol, the addresses comprise a dialing prefix of N bits and a machine identifier of 128 less N bits, the dialing prefix corresponding to the addresses of sub-networks and itself comprising two main parts:
The TLA (Top Level Aggregator) which defines the Internet public topology.
   Generally, the TLA is provided by an Internet operator. It can be of “local site” type, in which case the dialing prefix can only be used within the site.
The SLA (Site Level Aggregator) which defines the Internet topology of a site: the SLA is usually put under the responsibility of the site administrator.
   The Ipv6 addressing architecture, for the already allocated ranges, defines a 64-bit dialing prefix. The recommended standard allotment is 48 bits for the TLA and 16 bits for the SLA.

The method applies to networks generally using the Ipv6 Internet Protocol. Nevertheless, it is better suited to local area networks LAN using the Ipv6 Internet Protocol.

It makes a Master router and a dialer intervene that can be inserted either into a server or into a network router, and uses the process of self-configuration of the Ipv6 protocol which allows equipment to automatically configure itself according to the information it receives from the router(s) connected to the same link, by means of “Router Advertisement” type messages.

This process allowing to configure the Ipv6 addresses of the equipment performs the following operations:
The equipment self-generates a machine identifier usually by deriving it from the interface address (MAC) which it possesses.
The equipment builds a local link address from this identifying machine.
The equipment checks that it alone uses this address on the link.
The router diffuses, on the link, a message (router advertisement) comprising the list of dialing prefixes that it uses (TLA+SLA).
The equipment picks-up this message and generates an Ipv6 address.

The router can then acquire the TLA dialing prefix by means of Prefix Delegation and Router Renumbering mechanisms, specific to the IPv6 protocol.

To obtain an entirely automatic configuration, a mechanism allowing the automatic configuration of the SLA prefixes in the routers needs to be designed.

The invention attains these results thanks to a protocol for the automatic configuration of a network using an Ipv6 or analogue protocol, this network comprising a plurality of interconnected routers initially bearing the local link type addresses (non routable), on each of their interfaces (so that the Ipv6 routing functions are initially unusable).

According to the invention, this method is characterised in that, in order to use these routing functions, it consists in inserting a mechanism for allotting prefixes to the Ipv6 addresses of the network routers so as to be able to use the process of self-configuration of said protocol thanks to a mechanism making a dialer intervene which delivers said dialing prefixes according to an operating sequence comprising the following stages for each of the routers:
An initialisation stage in which the router has not as yet received a prefix issuing from the dialer and is therefore incapable of connecting to the dialer, this stage terminating when the router receives a Router Advertisement message, sent according to the self-configuration protocol by another router and which comprises the list of prefixes it uses.
A configuration stage actuated through the reception of the Router Advertisement message during which, thanks to the information contained in the Router Advertisement message, it self-configures a routing address on the interface through which the message came.
A relay stage in which the router has already received prefixes and is capable of connecting to the dialer. In this step the router intermediates between the dialer and other routers which are still in the configuration stage.

During the commissioning of the initialisation stage, the router searches in its backed-up information if the configuration has already been performed, and
If the configuration has already been performed, the router advances to the relay stage.
If the configuration has still not been performed:
   If the router is master, then the routed immediately advances to the configuration stage.
   If the router is not master, it remains alert on each of its interfaces.
   When it receives a Router Advertisement message for one of its interfaces:
      it records the address of the transmitting router as Upstream Router,
      it records the interface through which the message came as “primary interface”,
      it self-configures a routing address on the interface and records it as “primary address”,
      it advances to the configuration stage.

In the configuration stage, the router (that can be master) performs the following operations:
It attempts to connect to the dialer by querying as many prefixes from it as there are links to dial:
   If the router is master, it sends its query directly to the dialer, this configuration query containing the ordered list of primary addresses of the relays crossed, so that the dialer can respond to this query,
   If the router is not master, it sends its configuration query to its upstream router via the primary interface, the query comprising the primary address.
Upon receiving a reply from the dialer:
   It records the dialer address.
   If the router is master:
      it records the interface through which the reply came as primary interface,
      it self-configures a routing address on the interface and records it as primary address,
   it self-configures a routing address for every interface to be configured and records them,
   it starts to periodically diffuse the router advertisement messages on each interface,
   it advances to the relay stage.

In the relay stage, the router performs the following operations:
It receives the configuration queries issuing from other routers:
   it inserts its primary address in the query, these addresses being successively inserted in an orderly manner by each relay,
   it sends the new query either to its upstream router or directly to the dialer if the latter is accessible by the aforesaid Ipv6 protocol (which is always the case for the master).
It receives the configuration replies either from other routers or from the dialer:
   in the reply, the router searches for its own primary address,
   it selects the next address in the list,
   it sends the reply to this address.

An embodiment of the invention will be described below, by way of example, with reference to the annexed drawings in which:

FIG. 1 is a diagrammatic representation of an automatic dialing network according to the invention.

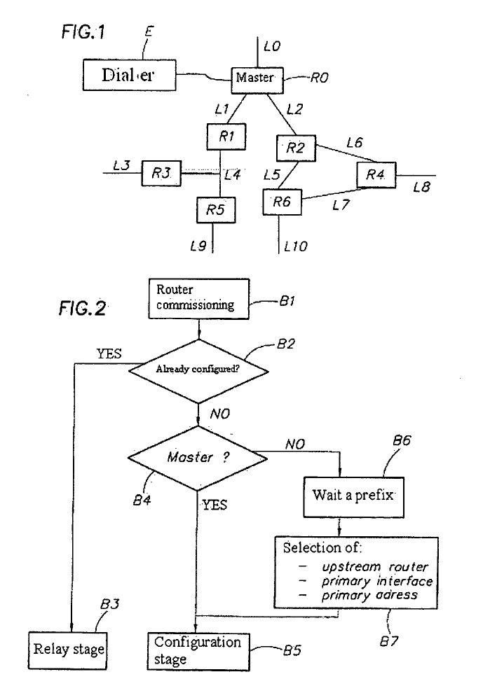

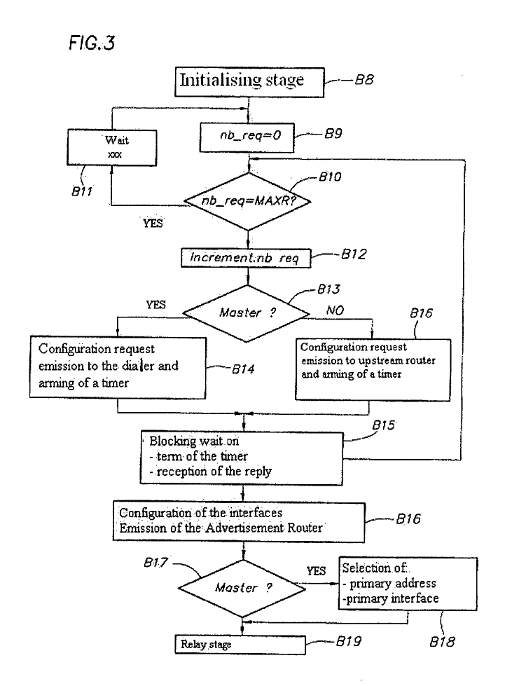

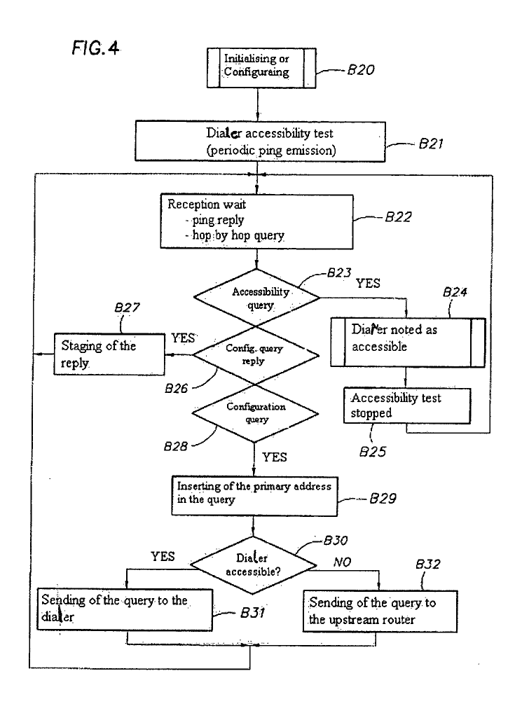

FIGS. 2 to 4 are algorithms of the initialisation (FIG. 2), configuration (FIG. 3) and relay (FIG. 4) stages of the method.

In the example illustrated in FIG. 1, the network comprises a plurality of routers R0 to R6 of which one R0 is endowed with a function called Master and equipment E endowed with a function called Dialer.

These routers are interconnected via linkages L0 to L10, level 2 network which forms two branches exiting from the router R0, that being a first branch comprising the router R1, linked to the routers R3 and R5 via the linkage L4, and a second branch comprising the router R2, linked, via the linkages L5 and L6, to the routers R4 and R6 which are interconnected by a linkage L7.

Furthermore, the routers R0, R3, R5, R6 and R7 are linked to network nodes (non represented) via the linkages L0, L3, L9, L10 and L8.

The Master and Dialer functions are specifically created for the requirements of the method according to the invention.

At the time of initialising, the routers R0 to R6 only have Ipv6 addresses of local link type on each of their interfaces. Thus, at the booting of their system, the routers R0 to R6 do not have any routing addresses and the routing functions of the Ipv6 protocol are therefore inoperable.

The Master and Dialer functions are linked: they can be inserted into the same machine. If this is not the case, the two machines must at least be accessible according to the Ipv6 protocol.

The dialer function can be inserted into either a server or a router.

The system administrator chooses a set of network prefixes and configures them in the dialers.

A single network can have several dialers but a given prefix must not be attributed more than once by the dialer(s).

An example of an algorithm is described below, in reference to FIGS. 2 to 4.

In the initialisation stage, during the commissioning of a router (block B₁), the system determines if this router (block B₂) has already been configured. In which case, it advances to the relay stage (block B₃). If the router has not been configured, the system determines if this router is a master router (block B₄). In which case, the system advances to the configuration stage (block B₅). If this is not the case, the router awaits a prefix (block B₆), then performs the selecting of an upstream router, a primary interface and a primary address (block B₇).

At the end of the initialisation stage (block B₈) the system advances to the configuration stage, it counts the number of queries, starting from a nil number of queries (block B₉) until it reaches a number of configuration queries equal to a maximum number of queries (MAXR). If this maximum number is reached (block B₁₀), the system goes into hold for a skeletal duration (block B₁₁) before re-launching a new set of queries (block B₁₂ and subsequent).

If the number of queries is less than the maximum number, the system increments the number of queries and determines whether it is a master router (block B₁₃).

In which case, the system issues a configuration query to the dialer and arms a timer (block B₁₄) which provokes a wait which blocks the term of the timer and the receiving of a reply issuing from the dialer (block B₁₅).

If the router is not a master router, the system emits a configuration query to the upstream router and then arms a timer (block B₁₆) which provokes the blocking wait provided for in block B₁₅.

At the term of the timer, the system rejoins at the junction of blocks B₉ and B₁₀. After receiving the reply from the dialer, the system configures the interfaces (block B₁₆) and emits router advertisement signals (block B₁₆). If it is a master router (block B₁₇), the system selects a primary address and a primary interface (block B₁₈), then advances to the relay stage (block B₁₉).

As illustrated in FIG. 4, the relay stage is initiated by an initialisation stage or a configuration stage (block B₂₀).

This stage is followed by a dialer accessibility test and by the periodic emission of a ping signal (block B₂₁).

The system then goes into reception wait, replies to the ping signal and launches a name testing process of the routers, one after the other (block B₂₂).

It then makes an accessibility query (block B₂₃). If this test is positive, the dialer is noted as accessible (block B₂₄) and the accessibility test is stopped (block B₂₅). The system then rejoins at the linkage between blocks B₂₁ and B₂₂.

If the test is negative, the system searches if a reply was emitted for the configuration query (block B₂₆).

If a reply to this query was emitted, the system stages the reply (block B₂₇) and rejoins at the linkage between blocks B₂₁ and B₂₂.

If no reply was emitted for this query, the system searches if a configuration query was emitted (block B₂₈).

If a configuration query was emitted, the system inserts the primary address in the query (block B₂₉).

The system then determines if the dialer is accessible (block B₃₀).

If the dialer is accessible, the system sends the query to the dialer (B₃₁), then returns to the linkage between blocks B₂₄ and B₂₂.

If the dialer is not accessible, the system sends the query to the upstream router (block B₃₂), then returns to the linkage between blocks B₂₁ and B₂₂.

The method according to the invention can be used in various fields.

It proved particularly useful for the deploying of local wireless networks such as those commonly used on project sites.

It also applies to home automation and military applications such as, for example, the parachuting of routers, applications in which the network topology is unknown.

Nevertheless, the size of the local area network (LAN) remains limited, given that several networks (LAN) can be juxtaposed and then interconnected.

Thus, for example:
The LAN can thus bear about ten routers and the same number of links.
The topology, a priori little-known, should remain stable during dialing.
This topology can then evolve all be it relatively slowly (for example, no more than one load per minute).

If the local area network (LAN) is connected to the Internet, it would be preferable to place the dialer and the master router alongside the routers linking the local area network to the Internet network.

1. Method for automatic network dialing using an Internet or analogue type protocol this network comprising a plurality of interconnected routers initially bearing local link type addresses on each of their interfaces, said method making a master router and a dialer intervene that can be inserted either into a server or into a network router using a process of self-configuration of said protocol which allows equipment to automatically configure itself according to the information it receives from the router(s) connected to the same link, by means of Router Advertisement type messages, wherein, in order to use the routing functions of said protocol, the method consists in inserting a mechanism for allotting prefixes to the Ipv6 addresses of the network routers so as to be able to use the process of self-configuration of said protocol thanks to a mechanism making a dialer intervene which delivers said dialing prefixes according to an operating sequence comprising the following stages for each of the routers:
an initialisation stage in which the router has not as yet received a prefix issuing from the dialer and is therefore incapable of connecting to the dialer, this stage terminating when the router receives a Router Advertisement message, sent according to the self-configuration protocol by another router and which comprises the list of prefixes it uses.
a configuration stage actuated through the reception of the Router Advertisement message during which, thanks to the information contained in the Router Advertisement message, it self-configures a routing address on the interface through which the message came,
a relay stage in which the router has already received prefixes and is capable of connecting to the dialer, the router thus intermediates between the dialer and other routers which are still in the configuration stage.

2. Method according to claim 1, wherein during the commissioning of the initialisation stage, the router searches in its backed-up information if the configuration has already been performed, and
if the configuration has already been performed, the router advances to the relay stage,
if the configuration has still not been performed:
if the router is master, then the routed immediately advances to the configuration stage,
if the router is not master, it remains alert on each of its interfaces,
when it receives a Router Advertisement message for one of its interfaces:
it records the address of the transmitting router as Upstream Router,
it records the interface through which the message came as primary interface,
it self-configures a routing address on the interface and records it as primary address,
it advances to the configuration stage.

3. Method according to claim 1, wherein in the configuration stage, the router performs the following operations:
it attempts to connect to the dialer by querying as many prefixes from it as there are links to dial:
if the router is master, it sends its query directly to the dialer, this configuration query containing the ordered list of primary addresses of the relays crossed, so that the dialer can respond to this query,
if the router is not master, it sends its configuration query towards the upstream router via the primary interface, the query comprising the primary address,
upon receiving a reply from the dialer:
it records the dialer address.
if the router is master:
it records the interface through which the reply came as primary interface,
it self-configures a routing address on the interface and records it as primary address,
it self-configures a routing address for every interface to be configured and records them,
it starts to periodically diffuse the router advertisement messages on each interface,
it advances to the relay stage.

4. Method according to claim 1, wherein in the relay stage, the router performs the following operations:
it receives the configuration queries issuing from other routers:
it inserts its primary address in the query, these addresses being successively inserted in an orderly manner by each relay,
it sends the new query either to its upstream router or directly to the dialer if the latter is accessible by the aforesaid protocol (Ipv6 (which is always the case for the master)),
it receives the configuration replies either from other routers or from the dialer:
in the reply, the router searches for its own primary address,
it selects the next address in the list,
it sends the reply to this address.
